(19) United States
(12) Patent Application Publication
(10) Pub. No.: US 2011/0137705 A1
(43) Pub. Date: Jun. 9, 2011

(54) METHOD AND SYSTEM FOR AUTOMATED CONTENT ANALYSIS FOR A BUSINESS ORGANIZATION

(75) Inventor: VENKAT SRINIVASAN, WESTON, MA (US)

(73) Assignee: RAGE FRAMEWORKS, INC.,, WESTWOOD, MA (US)

(21) Appl. No.: 12/963,907

(22) Filed: Dec. 9, 2010

Related U.S. Application Data
(60) Provisional application No. 61/267,943, filed on Dec. 9, 2009.

(51) Int. Cl. G06Q 10/00

(52) U.S. Cl. 705/7.28

(57) ABSTRACT

A method and a system for automated content analysis to assess impact on one or more business organizations. Content is aggregated from at least one content provider. The aggregated content is classified in knowledge ontology on the basis of a plurality of attributes of the content. Subsequently, a score is assigned corresponding to the impact of the classified content on the business organization in accordance with a set of scoring rules. Finally, a graphical representation is generated showing a cumulative score corresponding to the impact of the content on the business organization assessed during a predefined time period.

### REFERENCE TO RELATED APPLICATIONS

This application claims priority from U.S. Provisional Patent Application Ser. No. 61/267,943 (filed on Dec. 9, 2009 titled “Method and System for Automated Content Analysis for Assessing Impact of Real Time Content on a Business Organization”), the content of which is incorporated herein by reference.

### FIELD OF THE INVENTION

The present invention relates generally to content analysis and, more specifically, to a method and system for automated content analysis for a business organization.

### BACKGROUND OF THE INVENTION

In the world of financial markets, individual and financial institutional investors buy and sell securities of a business organization with the objective of achieving capital gains and income. The value of a business organization's securities is strongly correlated with the growth and development of the business organization. In particular, the value of the business organization depends on its expected future financial performance.

Investors rely on a myriad of information sources and methods to value a business organization's securities and make their investment decisions. These approaches can be broadly described as fundamental and quantitative. Typically, in the quantitative approach, numerous quantitative analysts develop statistical and quantitative financial models using vast amount of data. These models are used to identify patterns in the data that provide them insight that can be used in their investment decisions. In the fundamental approach, analysts rely on fundamental data and qualitative research on the fundamental characteristics of an organization in order to arrive at their investment decisions. Information used by fundamental analysts typically includes financial data provided by the organization, for example, filed with the United States Securities Exchange Commission, research provided by various research and consulting organizations, and analysis of developments around the world that can impact the business organization of interest.

The analysis of development around the world forms an important input for various aspects of the process, such as building financial models, etc. Investors seek to identify “insight” from development on a daily basis including news and other content in terms of the potential impact of such developments on the performance of the business organization and the value of its securities. In recent years, the Internet has emerged as a great source of such content such as news, newsletters, articles, blogs, etc. A huge amount of information related to publicly traded business organizations/companies is available on the Internet. Besides, numerous content providers, such as Bloomberg™, also create or aggregate content related to business organizations, industries, etc.

Conventional manual methods for analyzing such content to predict the impact on a business organization have numerous disadvantages. For example, there is an enormous amount of content that is generated almost on a continuous basis and it is very difficult for the analyst to manually identify the development that might impact a specific business organization. The manual process is time consuming and completely error prone. Further, the inability of humans to process or remember vast amount of information is well recognized and the current manual analytical processes require the analyst to manually process the content that is available to them. This leads to inconsistent and erroneous inferences over time. Moreover, humans have a well recognized tendency to weight the most recent information disproportionately. Additionally, the analysts are limited in their capacity with respect to the number of business organizations they can monitor as the effort involved in manual analysis of all developments is significantly high. Thus, considering the aforesaid points, it is desirable to have a systematic and automated method to aggregate, classify, and assess the impact of content.

One of the methods for conducting automated content analysis known in the art is ‘sentiment analysis’. In sentiment analysis, relevant sources of information, such as preferred websites, newsgroups, bulletin boards, and databases, are identified. Thereafter, various content aggregation methods are employed to retrieve content related to a business organization from the relevant sources of information. Subsequently, computational tools based on natural language processing technology are used to interpret the retrieved content to assess the general sentiment or opinion expressed in the text. The sentiment analysis method is sufficient to grade the content in terms of positive and negative sentiments. However, such a method is inappropriate to assess the impact on a business organization because it lacks the ability to assess the context and relevance of the content for a specific business organization. For example, content positive for one business organization may be negative for another organization. Moreover, the sentiment analysis method does not assess the degree of impact of the content on a business organization over a period of time.

Another method used to analyze the content known in the art is Natural language processing (NLP), which refers to a variety of statistical techniques, such as Latent Semantic Analysis (LSA) or Latent Semantic Indexing (LSI), Probabilistic Latent Semantic Analysis (PLSA) or Probabilistic Latent Semantic Indexing (PLSI), or any combination thereof. These methods attempt to identify commonality and patterns in the text across the documents. NLP is useful to analyze huge amount of documents and identify commonality or to generate models, for example, Support Vector Machines [SVM] but cannot assess specific context for a business organization. Additionally, the aforementioned methods need a large number of sample documents to achieve an acceptable level of extrapolation of data.

In light of the foregoing discussion, there is a need for a method and a system for automated content analysis for a business organization. An automated approach of content analysis saves a lot of effort and time required by human. Further, the method and system should allow the incorporation of relevant context for the business organization.

### SUMMARY OF THE INVENTION

An objective of the present invention is to provide a method for automated content analysis for one or more business organizations. The method includes aggregating content from one or more content providers. The content provider provides content that has information corresponding to various developments. The aggregated content is classified in a knowledge ontology based on a plurality of attributes of the content in accordance with a set of classification rules. Subsequently, a score is assigned corresponding to the impact of the content on the business organizations in accordance with a set of scoring rules. The scoring rules reflect the purpose of the analysis. Lastly, a graphical representation is generated showing the cumulative score corresponding to the impact of the content on each business organization assessed during a predefined time period. The cumulative score reflects an ongoing assessment of the impact of dynamic developments on the business organization.

Yet another objective of the present invention is to provide an impact assessment system for automated content analysis for a business organization. The impact assessment system includes a content aggregating module for aggregating the content from one or more content providers. The content aggregating module provides the aggregated content to a content classification module that classifies the content according to a knowledge ontology based on a plurality of attributes of the content in accordance with a set of classification rules. The impact assessment system further includes a scoring module for assigning a score corresponding to the impact of the content on the business organization in accordance with a set of scoring rules. Further, the impact assessment system includes a graphical interface module for generating a graphical representation. The graphical representation shows a cumulative score corresponding to the impact of the content on the business organization assessed during a predefined time period.

Additionally, the present invention facilitates an automated content analysis for a business organization. The content is aggregated and classified in a knowledge ontology which significantly reduces the amount of effort and time required to organize the vast amount of information available to the analysts. Subsequently, to reflect the impact of the content on the business organization, a score is assigned by an impact assessment system which significantly reduces the amount of effort and time required for making informed investment decisions. The automated content analysis method helps the analysts to focus on the most important and critical developments instead of getting distracted in the mass of information a large portion of which is generally irrelevant.

### BRIEF DESCRIPTION OF THE DRAWINGS

Various embodiments of the present invention will hereinafter be described in conjunction with the appended drawings that are provided to illustrate and not to limit the present invention, wherein like designations denote like elements, and in which:

FIG. 1 depicts a computational system in which various embodiments of the present invention can be practiced, in accordance with an embodiment of the present invention;

FIGS. 2A and 2B depict knowledge ontology and a set of functional nodes corresponding to an organization specific ontology respectively, for automated content analysis for a business organization, in accordance with an embodiment of the present invention;

FIG. 3 is a flow diagram illustrating a method for automated content analysis for a business organization, in accordance with an embodiment of the present invention;

FIG. 4 is an exemplary graphical representation illustrating impact of content on a business organization, in accordance with an embodiment of the present invention;

FIG. 5 is an exemplary portfolio-management map illustrating impact of content on one or more business organizations, in accordance with an embodiment of the present invention;

FIG. 6 is a flow diagram illustrating a method for configuring a knowledge database that facilitates automated content analysis to assess impact on a business organization, in accordance with an embodiment of the present invention; and

FIG. 7 is a block diagram illustrating an impact assessment system, in accordance with an embodiment of the present invention.

Skilled artisans will appreciate that the elements in the figures are illustrated for simplicity and clarity to help improve understanding of the embodiments of the present invention, and are not intended to limit the scope of the present invention in any manner whatsoever.

### DETAILED DESCRIPTION OF THE INVENTION

Various embodiments of the present invention relate to a method and a system for carrying out an automated content analysis to assess impact on one or more business organizations. The content related to various developments is aggregated from at least one content provider accessible through a network. The aggregated content is classified in a knowledge ontology on the basis of a plurality of attributes of the content identified using a set of semantic rules. The knowledge ontology includes a domain-specific ontology and an organization-specific ontology. The knowledge ontology is a network of interconnected causal factors that describe the operating environment of the business organization. Subsequently, a score is assigned to identify the impact of the content on the at least one business organization. Additionally, the step of scoring is performed depending upon the end objective of the users/entities implementing the invention. For example, a user may choose not to use the scoring functionality if he/she is using the current invention for example, for research purposes. Alternatively, the user may choose to use the scoring functionality if he/she is using the current invention for the purpose of discovery process such as litigation cases.

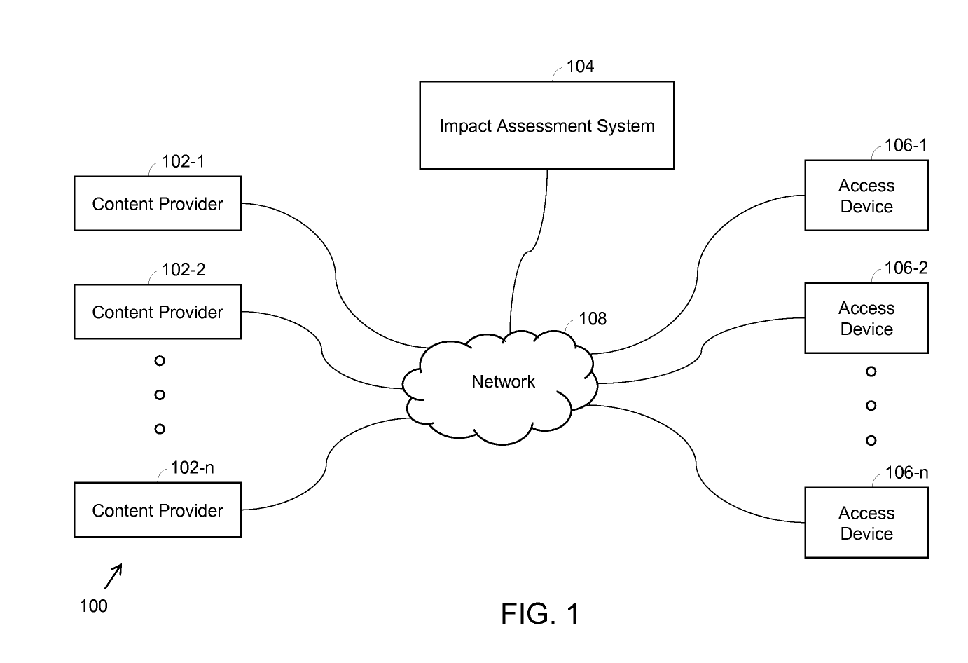

FIG. 1 depicts a computational system 100 in which various embodiments of the present invention may be practiced. Computational system 100 includes one or more content providers shown as 102-1, 102-2 . . . 102-n (collectively referred to as content providers 102), an impact assessment system 104 and one or more access devices 106-1, 106-2 . . . 106-n (collectively referred to as access devices 106) interconnected through a network 108.

Content providers 102 include primary content providers that create content to provide information related to various diverse subject matters. Content providers 102 further include secondary content providers that aggregate content from various primary content providers accessible through the Internet. Examples of content providers 102 include, but are not limited to, websites/portals such as Yahoo!™, Google™, and Bloomberg™. Various examples of content include text documents, HTML pages, Rich Site Summary (RSS) feeds, newsgroup messages, and bulletin boards. Content providers 102 provide content including information on diverse subject matters. In various embodiments of the present invention, content providers 102 provide business or financial news. Further, the business or financial news is assessed to determine its relevancy for business organizations.

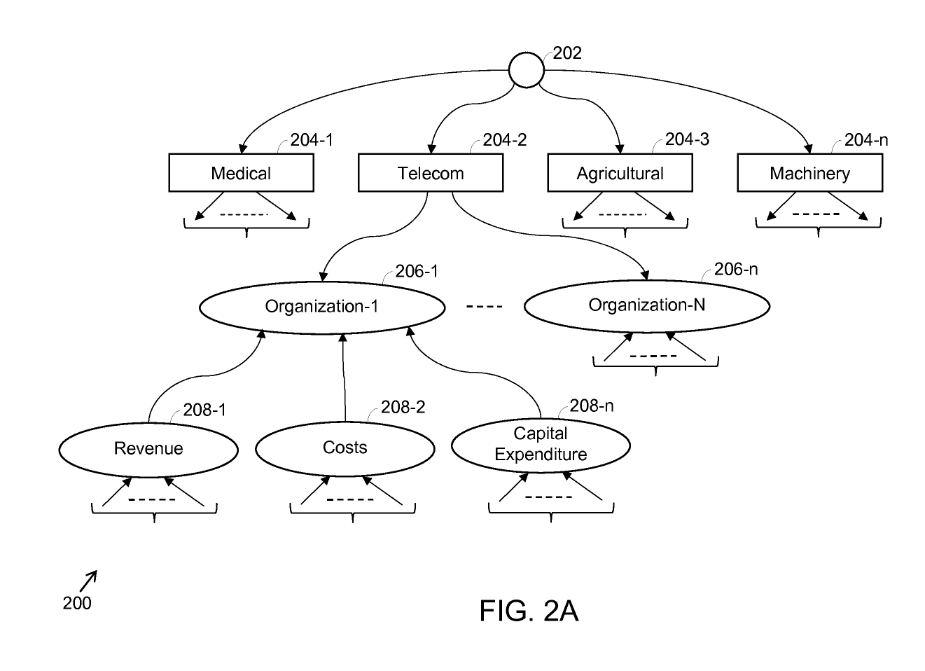

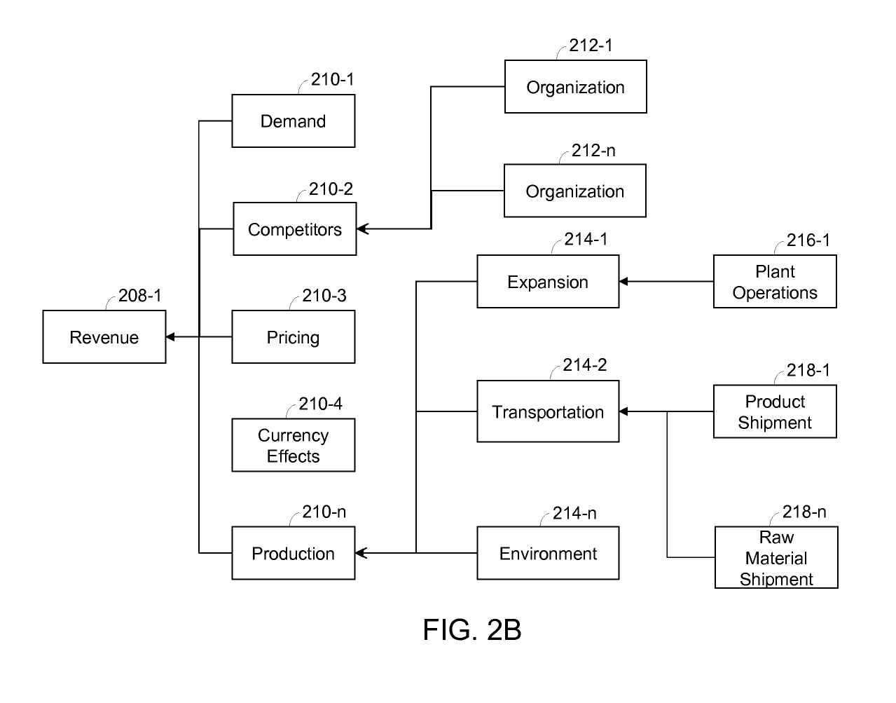

Impact assessment system 104 is a computational system connected to network 108. Impact assessment system 104 includes a knowledge ontology, which includes a set of nodes corresponding to various factors, internal and external to the business organization, that may impact the financial performance of one or more predefined business organizations. It must be noted that the knowledge ontology will be explained in detail in conjunction with FIGS. 2A and 2B. Impact assessment system 104 includes one or more tools to aggregate content related to diverse subject matters from content providers 102. The aggregated content is parsed in accordance with a set of semantic rules. Thereafter, the aggregated content is classified in the knowledge ontology on the basis of a set of classification rules. Subsequently, impact assessment system 104 assesses the impact of the content on the financial performance of the one or more business organizations.

Access devices 106 are digital devices capable of communicating over network 108. Examples of access devices 106 include, but are not limited to, mobile phones, laptop or desktop computers, personal digital assistants (PDAs), pagers, programmable logic controllers (PLCs), and wired phone devices. Access devices 106 communicate with impact assessment system 104 and retrieve information related to impact on one or more business organizations. Access devices 106 communicate with the impact assessment system 104 through any suitable client application, such as a web browser and a desktop application, configured to communicate with impact assessment system 104. In various embodiments of the present invention, any desired number of content providers 102 and access devices 106 may participate in computational system 100. In various embodiments of the present invention, network 108 may be a local area network (LAN), a wide area network (WAN), a satellite network, a wireless network, a wire-line network, a mobile network, or other similar networks.

FIGS. 2A and 2B depict knowledge ontology 200 and a set of functional nodes corresponding to an organization specific ontology respectively, for automated content analysis for a business organization, in accordance with an embodiment of the present invention.

Knowledge ontology 200 includes a set of nodes corresponding to various business factors that may impact the financial performance of one or more business organizations in various industry segments. Knowledge ontology 200 includes a root node 202, one or more domain nodes 204, one or more business organization nodes 206, and one or more functional nodes 208 and 210. Knowledge ontology 200 is a hierarchical model with a plurality of levels. The domain nodes 204 are at level 1, the organization nodes 206 are at level 2, the functional nodes 208 are at level 3, and so on. Since some factors impact multiple industries, therefore, these factors may be present in multiple levels of the ontology.

Knowledge ontology 200 includes one or more domain-specific ontologies (starting with domain node 204); each of the domain-specific ontologies includes one or more organization-specific ontologies (starting with organization node 206). Root node 202 is a parent node for one or more domain nodes 204. Each domain node 204, in turn, is a parent node for one or more organization nodes 206. Each organization node 206 is a parent node for one or more functional nodes 208, and so on. In the example shown in FIG. 2A, a telecom domain-specific ontology starts from domain node 204-2 and includes ‘n’ organization-specific ontology corresponding to organizations from 1 to n. The domain node 204-2 includes organization nodes 206-1 to 206-n, and organization node 206-1 includes functional nodes 208-1 to 208-n. Further, each functional node 208 may, in turn, be a parent node for other functional nodes 210-1 to 210-n (as shown in FIG. 2B).

In accordance with an embodiment of the present invention, knowledge ontology 200 is a multi-relational ontology which includes pairs of related concepts. A broad set of descriptive relationships connect each pair of related concepts. Each concept within a concept pair may also be paired with other concepts within knowledge ontology 200. Thus, a complex set of logical connections is formed within the various concepts included in knowledge ontology 200.

Knowledge ontology 200 is based on an operating model of various business organizations. Each functional node 208 in the organization-specific ontology corresponds to a concept derived from the operating model of the various business organizations. Functional nodes 208 are grouped on the basis of interrelationships and interdependencies between the corresponding concepts to generate the organization-specific ontology.

FIG. 2B depicts a set of functional nodes 210-1 to 210-n, 212-1 to 212-n, 214-1 to 214-n, 216-1, and 218-1 to 218-n corresponding to the organization specific ontology for organization-1. As explained above that each functional node 208 may, in turn, be a parent node for other functional nodes 210-1 to 210-n. For example, the revenue of a business organization is a function of demand, competitors, pricing, currency effects, and production of various products in company's product portfolio. Thus, functional node 208-1 corresponding to “Revenue” is a parent node for the functional nodes 210-1, 210-2, 210-3, 210-4, and 210-n, corresponding to “Demand”, “Competitors”, “Pricing”, “Currency Effects”, and “Production” respectively. Further, competitors 210-2 for organization-1 can be any organization with same product portfolio and targeting the same market as organization-1, such as organizations 212-1 to 212-n.

Additionally, the production 210-n of the organization-1 is a function of expansion 214-1, transportation 214-2, and environment 214-n. Expansion 214-1 in turn of the organization-1 is a function of plant operations 216-1 and transportation 214-2 is a function of product shipment 218-1 and raw material shipment 218-n, and so on. It will be apparent to a person of ordinary skill in the art that there may be other functional nodes corresponding to nodes 210-1, 210-3, and 210-4.

Organization specific ontology is grouped together in accordance with the corresponding industry segments to generate domain-specific ontology.

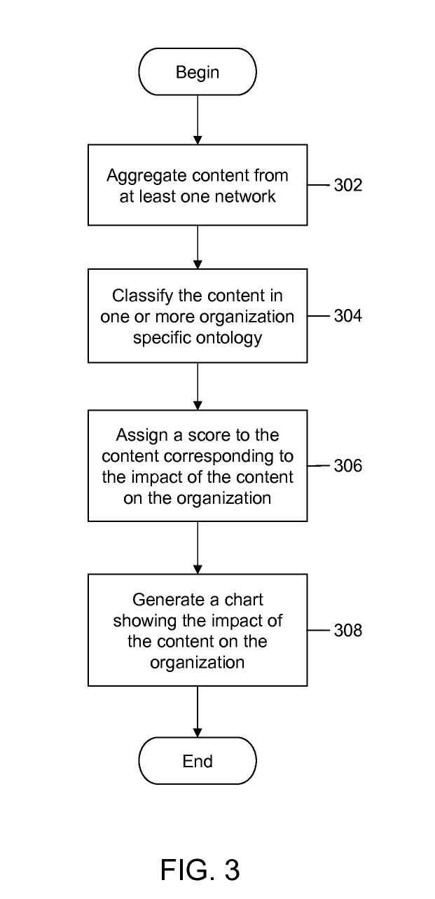

FIG. 3 is a flow diagram illustrating a method for automated content analysis for a business organization, in accordance with an embodiment of the present invention.

At step 302, content related to diverse subject matters is aggregated from one or more content providers using one or more tools. Various examples of content include text documents, HTML pages, Rich Site Summary (RSS) feeds, newsgroup messages, and bulletin boards. The content aggregation is performed using an aggregation module which includes a web crawler, a content downloader, and an RSS feed reader. The web crawler is used for accessing web sites and downloading content from those web sites. Further, the content downloader can be used for accessing and downloading content on the network (Internet). Moreover, the RSS feed reader is used for consuming RSS feeds.

A web crawler is a software program which retrieves and stores the content contained in one or more web pages and is used to access web sites. A content downloader is a software program capable of downloading web pages, images, and other data from one or more websites in the network. An RSS reader receives content from web pages which publishes the content. The aggregated content is stored in a knowledge database. In accordance with an embodiment of the present invention, the content is aggregated in real-time using the content aggregation module and content specification rules. Thus, the content is aggregated rapidly after its release.

The aggregated content is parsed and semantic analysis techniques are used to identify a plurality of attributes, such as geographic scope, time, impact, and topic, of the content on the basis of a set of semantic rules.

The semantic rules extract a set of keywords and phrases along with their linguistic attributes while parsing the content. In one example, the set of semantic rules are used to identify the subject, verb, adjective, noun, and their interrelationships in the text. The keywords are used to identify synonyms, acronyms, and antonyms, which are used to standardize the content to facilitate further processing. For example, “IBM Ltd.,” “I.B.M.,” and “International Business Machines” may be standardized to represent “IBM.” One or more phrases are extracted from the content; for example, if the content is related to a news item “Microsoft Corp. announces free antivirus, limited public beta!,” the identified phrases may include “Microsoft Corp,” “announces”, “free antivirus,” “limited public beta,” and “public beta.” In some instances, every possible combination of phrases may be extracted from the content. Further, there may be instances where a phrase is inferred. For example, “Corp.” may be interpreted as “Corporation” or vice versa. Words in the extracted phrases can be expanded or abbreviated. The linguistics attributes of each phrase is identified. For example, Microsoft is a noun, “announces” is a verb, “limited public beta” is a noun phrase with “limited” being an adjective. Furthermore, to maintain consistency, the identified phrases may be normalized and duplicate words or phrases may be removed. In one example, these phrases are used to extract keywords from the content. The extracted keywords and phrases are processed to define the values of the plurality of attributes of the content.

The plurality of attributes may include, but are not limited to, topic, geographic scope, impact, and time of the content. For example, for a content related to a news item “Increase in demand for pulp in China”, the plurality of attributes is identified as geographic scope: China, impact: increase, time is calculated since the information was first announced, and topic: pulp demand. It will be apparent to a person of ordinary skill in the art that the various attributes are identified from the various parts of the content, for example, title and full textual content.

In one embodiment of the present invention, the content is aggregated from various content providers. The various content providers may provide the same content which may result in duplicate content. To ensure proper assessment of the content, the duplicate content needs to be removed. Therefore, the content is de-duplicated before performing other processing steps by the impact assessment system 104.

At step 304, the content is classified in one or more organization-specific ontologies on the basis of the plurality of attributes of the content and a set of classification rules. These classification rules and the organization-specific ontologies are developed using a combination of natural language processing techniques such as Latent Semantic Analysis (LSA) or Latent Semantic Indexing (LSI), Probabilistic Latent Semantic Analysis (PLSA) or Probabilistic Latent Semantic Indexing (PLSI), or any combination thereof, and linguistics which refers to the linguistic structure of the content. In various embodiments of the present invention, the attributes of the content are compared with the concept definition of each node at a given level in the organization-specific ontology. The relevant nodes are selected and the attributes of the content are compared with all the child nodes of each relevant node at the next level, and the process is repeated until the last level in the knowledge ontology 200.

In various embodiments of the present invention, the content is first classified in a domain-specific ontology. In the same manner, the content is classified for an organization-specific ontology and then, in one or more organization-specific ontologies. The content is logically appended to each relevant node identified in this process.

Referring to knowledge ontology 200 illustrated in FIGS. 2A and 2B, in one example, the content related to “Decrease in supply of heavy machinery parts” is directly linked with machinery domain 204-n, but may affect the organizations under medical domain 204-1 and agriculture domain 204-3. Therefore, the plurality of attributes of the content is compared with each node of the domain-specific ontology 204-1 to 204-n. Once the relevant domains of the content are identified, the plurality of attributes of the content is compared with the organization nodes 206 to determine the relevant organizations. Subsequently, one or more functional nodes 208 and 210 under the relevant organization nodes 206 are identified.

At step 306, a score is assigned corresponding to the impact of the content on the business organization. Each business organization is associated with a set of scoring rules that are used to assign a score. The set of scoring rules includes a set of named entities with predefined implications. The implication can be defined in terms such as “positive,” “negative,” and “neutral.” Further, each organization may have a different implication for the same content. For example, a news item related to “Decrease in Wheat Prices” may have a positive impact on a bread manufacturing organization, but at the same time, may have a negative impact on a wheat manufacturing organization. Accordingly, the scoring rules are prepared to reflect the impact of the content on various business organizations.

The score is a numerical value ranging from a positive value to a negative value that is assigned to reflect the impact of the content on the business organization, for example, the content may be scored on a scale ranging from −10 to +10. The scale used for scoring will reflect the granularity of the desired outcome and correspond to the granularity of the impact assessment system.

Subsequently, at step 308, a graphical representation is generated that shows the impact of the content on the business organization. Various exemplary graphical representations, in accordance with various embodiments of the present invention, include a line chart, a bar chart, a heat map, or a combination thereof.

It will be apparent to a person of ordinary skill in the art that there are many other examples where automated content analysis using the present invention can be implemented. For example, in various litigation cases, lawyers may want to analyze documents related to the case from the other side to the litigation in order to determine their degree of relevance.

In another example, a user wants to perform an ad-hoc research on a topic, for example, a student writing a term paper. In this case, the results from the network 108 are classified in relevant ontologies based on the plurality of attributes based on the detailed contextual information other than only the phrase used to describe the topic. Further, for such cases the implementation of the present invention may end at the classification of the results into relevant knowledge ontologies and accordingly, may not assign any cumulative score to the classified content or results or generate a graph based on the score.

For one of ordinary skill in the art, it is understood that the sequence of steps described in the flow chart above is exemplary in nature and that it is used to facilitate the description of the present figure. There may be other possible sequences of the steps that can be performed to implement the invention described in the figure. Accordingly, it is clear that that the invention is not limited to the embodiment described herein. Additionally, the steps of the present invention may be performed based on the requirements of entities/users implementing the invention.

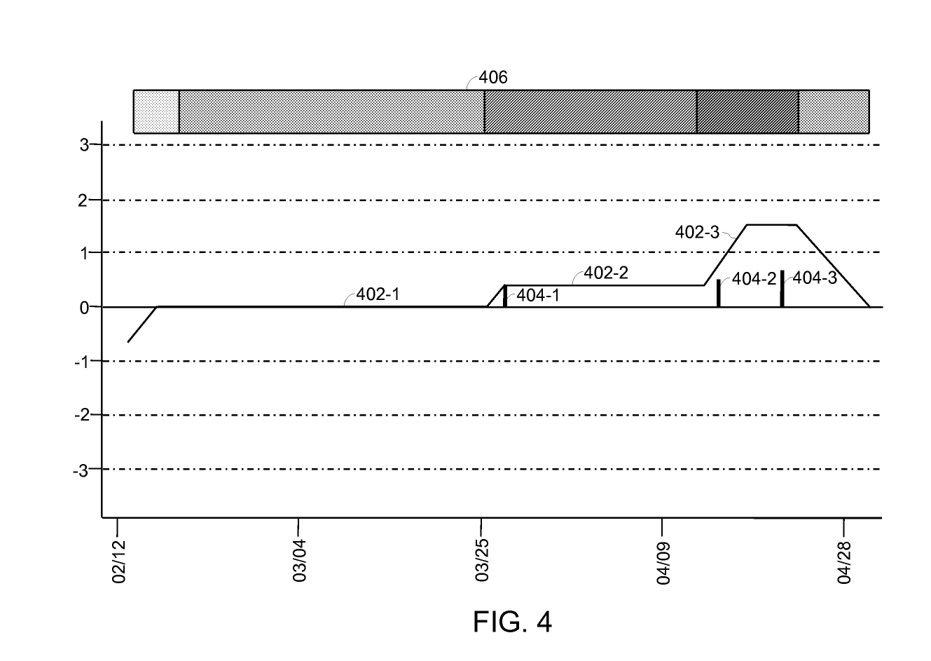

FIG. 4 is an exemplary graphical representation illustrating impact of content on a business organization, in accordance with an embodiment of the present invention.

In this example, the horizontal axis represents predefined time in which the financial-impact assessment was performed, while the vertical axis represents the score assigned as a result of the financial-impact assessment. Lines 402-1 to 402-3 in the graph show the impact of the content on a business organization “X.” Bars 404-1 to 404-3 show the impact of the content provided by security research analysts using conventional techniques.

The graph is generated for a set of aggregated content for a predefined time interval; for example, the impact of the content aggregated for the time interval between Feb. 12, 2008, and Apr. 28, 2008.

In accordance with an embodiment of the present invention, any suitable time period may be defined to generate the graph. The impact assessment system 104 collates the content within the specified time period and plots a trend line of the cumulative score corresponding to the impact of the aggregated content.

Additionally, the graph shows first and second order impacts over the predefined time interval. The first order impacts are based on the intrinsic developments corresponding to the business organization “X;” for example, a product launch or any merger- or acquisition-related decision taken by the business organization “X.” The second order impacts are based on the extrinsic developments corresponding to the business organization “X;” for example, increase or decrease in exchange rates.

The graph shows both first and second order impacts of the content on the business organization “X” which in one example is a medical instrument manufacturer. The content related to “Impressive results achieved by Negative Pressure Wound Therapy (NPWT) products” and “Launch of product for total knee replacement” was assigned a positive score by the impact assessment system 104 and the security research analysts. Therefore, the impact of both news items is the same as shown by lines 402-1 to 402-2 and bar 404-1 and 404-2 in the graph. The content related to NPWT products and total knee replacement product accounted for the first order impacts on the business organization “X.” Further, the content related to “Swine flu fears,” which accounts for the second order impacts, was assigned a positive score; therefore, the line 402-2 further rose to 402-3. The impact assessed (represented by line 402-3) by impact assessment system 104 becomes more positive as compared with line 402-2. However, for the same duration, the impact assessed by the security research analysts remains almost the same as represented by bars 404-2 to 404-3. Impact assessment system 104 reported high earnings for the business organization “X” which was the same as declared by the business organization. Furthermore, the recommendations provided by the security research analysts were not the same as the impact represented by bars 404-2 to 404-3 for the time interval Apr. 9, 2008, to Apr. 28, 2009.

As shown in FIG. 4, the financial-impact assessment is presented in the form of a heat map, in which the cumulative score (positive or negative) as of a point in time is represented by different color codes. FIG. 4 includes a set of color codes 406 used to represent the impact of the content on the business organization “X” within the predefined interval of time.

Those of ordinary skill in the relevant art can appreciate that the embodiments described above are exemplary in nature and are simply used to facilitate the description of the present figure. Accordingly, it is understood that the invention is not limited to the embodiments described herein.

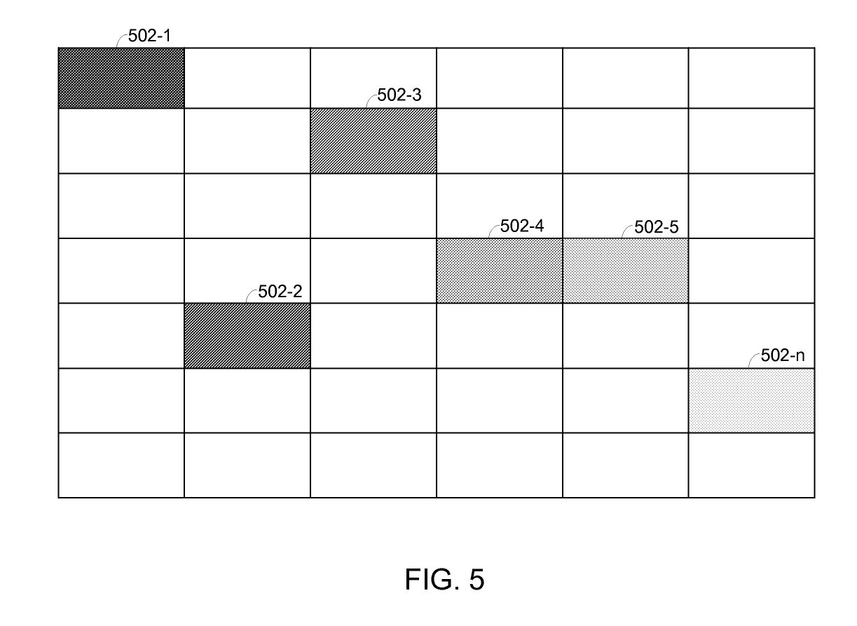

FIG. 5 is an exemplary portfolio-management map illustrating the impact of content on one or more business organizations, in accordance with an embodiment of the present invention. FIG. 5 includes the financial-impact assessment of the one or more business organizations 502-1 to 502-n.

The content is aggregated from the at least one content provider and the impact of the content is assessed by impact assessment system 104. Further, cumulative scores are assigned corresponding to the impact of the content aggregated and assessed over a desired period of time on the business organizations. Subsequently, a portfolio-management map is generated which indicates the varying performance levels of the business organizations represented in blocks 502-1 to 502-n by using a set of color codes. As shown in FIG. 5, business organization 502-1, 502-2, and 502-3 may be impacted favorably by developments, and consequently, reflect a positive cumulative score as compared with business organizations 502-4, 502-5, and 502-n.

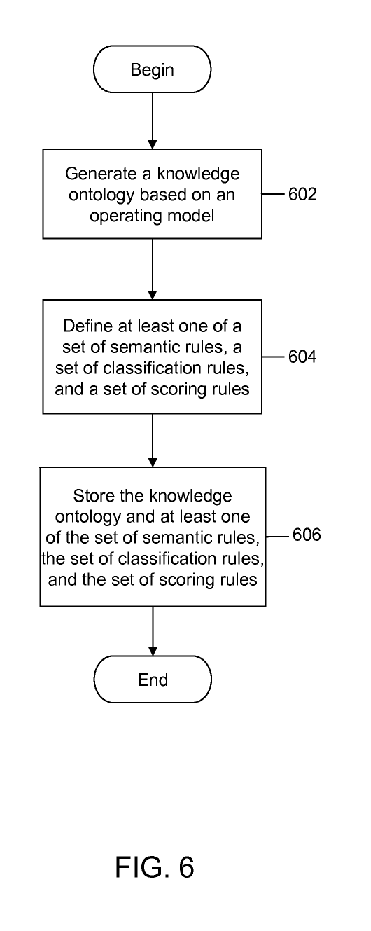

FIG. 6 is a flow diagram illustrating a method for configuring a knowledge database facilitating automated content analysis for a business organization, in accordance with an embodiment of the present invention.

At step 602, knowledge ontology 200 is generated on the basis of an operating model of one or more business organizations. The one or more business organizations operate in one or more industry domains. In accordance with an embodiment of the present invention, the one or more business organizations corresponding to the one or more industry domains are identified. Referring to FIGS. 2A and 2B, for example, the operator may identify organizations from 1 to N corresponding to a “telecom” industry domain 204-2. Further, the knowledge ontology for a specific organization is generated on the basis of the operating business models of one or more business organizations.

At step 604, at least one of a set of semantic rules, classification rules, and scoring rules is defined. The set of semantic rules, classification rules, and scoring rules are used to extract keywords and phrases from the content, to classify the content in the knowledge ontology, and to assign a score corresponding to the impact of the content on the business organization, respectively.

At step 606, the knowledge ontology 200 is stored and at least one of the set of semantic rules, classification rules, and scoring rules is stored in a knowledge database of impact assessment system 104.

In various embodiments of the present invention, the knowledge ontology 200 and the at least one of the set of semantic rules, classification rules, and scoring rules are updated on the basis of a first and a second predefined criterion respectively. The required updates may be scheduled at regular intervals. Alternatively, an administrator of impact assessment system 104 may configure the updates on a need basis.

Further, the knowledge ontology 200 is developed using a combination of Natural Language Processing (NLP) and linguistic methods such that appropriate context can be set for the classification and scoring rules. In order to develop the knowledge ontology, various natural language processing methods are used to provide a domain expert with summarized set of attributes, such as concepts, topics, and impact phrases. The experts rapidly generate organization specific ontologies using their expert knowledge and with the information generated using NLP methods and add linguistic attributes based on their expertise. For example, to assess the impact corresponding to a particular news item, the expert can specify that the impact should be assessed by identifying the verb associated with the noun phrase that identifies the topic in the news item, etc. Thus, present invention allows a complete use of the linguistic attributes in the classification rules.

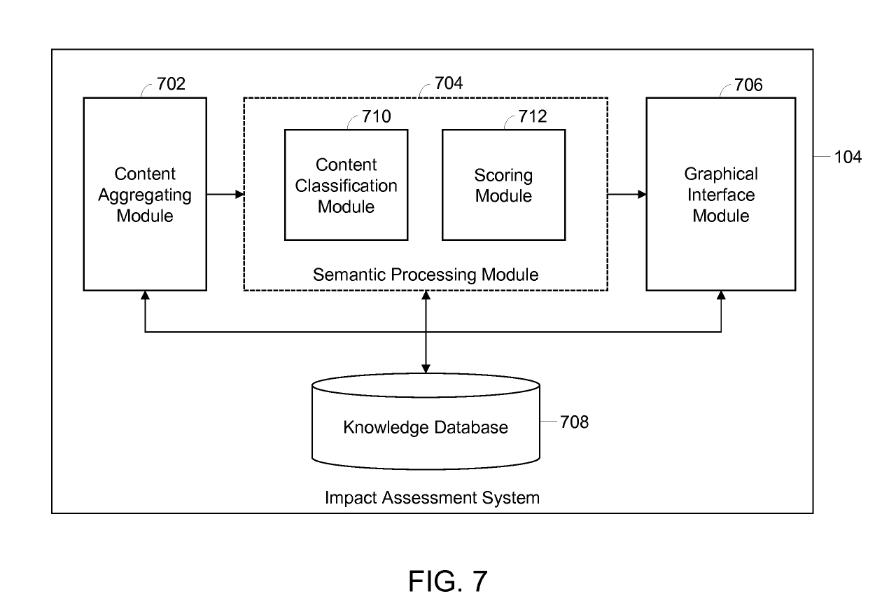

FIG. 7 is a block diagram illustrating impact assessment system 104, in accordance with an embodiment of the present invention. Impact assessment system 104 includes a content aggregating module 702, a semantic processing module 704, a graphical interface module 706, and a knowledge database 708. Semantic processing module 704 includes a content classification module 710 and a scoring module 712.

Content aggregating module 702 aggregates content from at least one content provider 102 (explained in detail in conjunction with FIG. 1). Various examples of content include text documents, HTML pages, Rich Site Summary (RSS) feeds, newsgroup messages, and bulletin boards. The content aggregation module includes the ability to crawl the web, download content on a network 108, and receive and use RSS feeds. The aggregated content is stored in knowledge database 708.

Semantic processing module 704 processes the aggregated content. Content classification module 710 uses a set of classification rules to classify the aggregated content in knowledge ontology 200. Content classification module 710 classifies the content as explained with the description of step 304 in conjunction with FIG. 3. Scoring module 712 assigns a score corresponding to the impact of the content on the business organization. The score is assigned using a set of scoring rules stored in knowledge database 708.

Graphical interface module 706 generates a graphical representation depicting the cumulative score assigned corresponding to the impact of the aggregated content during a selected time interval. Users may select a time period using the graphical interface provided on access device 107. Graphical interface module 706 also generates a portfolio-management map (as shown in FIG. 5).

Knowledge database 708 stores knowledge ontology 200, the semantic rules to parse the content, the classification rules to classify the content in knowledge ontology 200, and the scoring rules to assign a score to reflect the impact of the content on the business organization. In various embodiments of the present invention, knowledge ontology 200, the semantic rules, classification rules, and the scoring rules are updated by an administrator of impact assessment system 104 on the basis of real time developments. Knowledge database 708 also stores the aggregated content.

In accordance with an embodiment of the present invention, the users may select one or more industry segments and one or more business organizations according to their preferences using a graphical interface provided on access devices 107. The users may select a time period using the graphical interface provided on access device 107. Impact assessment system 104 assesses the impact of the content during the selected time period on the selected industry segments and the selected business organizations.

The present invention described above has numerous advantages. The present invention facilitates the process of conducting an automated content analysis to assess impact on a business organization. The present invention significantly reduces the amount of effort and time required to take informed investment decisions. The automated content analysis method helps investors cope with internal and external variables of the business organization which change rapidly with real time developments. Further, the scores assigned by the impact assessment system of the present invention provide more accurate assessment of the impact as compared with traditional methods.

The method and system, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices capable of implementing the steps that constitute the method of the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can either be a hard disk drive or a removable storage drive such as a floppy disk drive and an optical disk drive. The storage device can be other similar means for loading computer programs or other instructions into the computer system.

The computer system executes a set of instructions (or program instruction means) that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at, or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method for the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions (a program instruction means) can be embedded in a computer program product for use with a computer, the computer program product comprising a non transitory computer usable medium with a computer readable program code embodied therein. Processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A method for automated content analysis for assessing impact on one or more business organizations, the method comprising the steps of:
aggregating content from at least one content provider;
classifying the content in a knowledge ontology based on a plurality of attributes of the content in accordance with a set of classification rules, the knowledge ontology comprising one or more functional nodes corresponding to organization specific functional concepts;
assigning a score corresponding to the impact of the content on the business organization in accordance with a set of scoring rules; and
generating a graphical representation showing a cumulative score corresponding to the impact of the content on the business organization assessed during a predefined time period.

2. The method of claim 1 further comprising the step of identifying the plurality of attributes of the content based on a set of semantic rules.

3. The method of claim 1 further comprising the step of generating the knowledge ontology corresponding to an operating model of one or more business organizations operating in one or more industry domains.

4. The method of claim 1, wherein the knowledge ontology comprises a plurality of nodes organized at one or more levels, and wherein classifying the content in the knowledge ontology comprises identifying one or more relevant nodes at each level; and logically appending the content to each relevant node.

5. The method of claim 1, wherein classifying the content in the knowledge ontology is based on applying semantic rules using at least one natural language processing technique selected from a group including: latent semantic analysis, probabilistic latent semantic analysis, and computational linguistics.

6. The method of claim 1, wherein the knowledge ontology comprises at least one of one or more domain specific ontologies and one or more organization specific ontologies; and further wherein classifying the content in the knowledge ontology comprises at least one of classifying the content in one or more domain-specific ontology; and classifying the content in one or more organization specific ontology, using a set of classification rules.

7. The method of claim 1 further comprising the step of specifying the predefined time period using a graphical interface.

8. The method of claim 1 further comprising the step of updating the knowledge ontology based on a first predefined criterion.

9. The method of claim 1 further comprising the step of updating at least one of the set of semantic rules, the set of classification rules, and the set of scoring rules based on a second predefined criterion.

10. An impact assessment system for automated content analysis for assessing the impact on one or more business organizations, the impact assessment system comprising:
a content aggregating module for aggregating content from at least one content provider;
a content classification module for classifying the content in a knowledge ontology based on a plurality of attributes of the content in accordance with a set of classification rules, the knowledge ontology comprising one or more functional nodes corresponding to organization specific functional concepts;
a scoring module for assigning a score corresponding to the impact of the content on the business organization in accordance with a set of scoring rules; and
a graphical interface module for generating a graphical representation showing a cumulative score corresponding to the impact of the content on the business organization assessed during a predefined time period.

11. The impact assessment system of claim 10, wherein the content classification module further identifies the plurality of attributes of the content based on a set of semantic rules.

12. The impact assessment system of claim 10 further comprising a knowledge database comprising a knowledge ontology based on an operating model of one or more business organizations operating in one or more industry domains.

13. The impact assessment system of claim 10, wherein the knowledge ontology comprises a plurality of nodes organized at one or more levels, wherein the content classification module identifies one or more relevant nodes at each level; and logically appends the content to each relevant node in the knowledge ontology.

14. The impact assessment system of claim 10, wherein the knowledge ontology comprises at least one of one or more domain specific ontology and one or more organization specific ontology; and wherein the content classification module classifies the content in at least one of the one or more domain-specific ontologies and the one or more organization specific ontologies using a set of classification rules.

15. The impact assessment system of claim 10, wherein the knowledge database stores at least one of the set of semantic rules, the set of classification rules, and the set of scoring rules.

16. The impact assessment system of claim 10, wherein the content classification module classifies the content in the knowledge ontology based on at least one natural language processing technique selected from a group including: latent semantic analysis, probabilistic latent semantic analysis, and computational linguistics.

17. The impact assessment system of claim 10 wherein the graphical interface module provides a graphical interface for specifying the predefined time period.

18. The impact assessment system of claim 10, wherein the graphical interface module provides a graphical interface for updating the knowledge ontology in the knowledge database.

19. The impact assessment system of claim 10, wherein the graphical interface module provides a graphical interface for updating at least one of the set of semantic rules, the set of classification rules, and the set of scoring rules.

20. A computer program product for use with a computer, the computer program product comprising instructions stored in a non transitory computer usable medium having a computer readable program code embodied therein for automated content analysis for assessing impact on a business organization, the computer readable program code comprising:
program instruction means for aggregating content from at least one content provider;
program instruction means for classifying the content in a knowledge ontology based on a plurality of attributes of the content in accordance with a set of classification rules, the knowledge ontology comprising one or more functional nodes corresponding to organization specific functional concepts;
program instruction means for assigning a score corresponding to the impact of the content on the business organization in accordance with a set of scoring rules; and
program instruction means for generating a graphical representation showing a cumulative score corresponding to the impact of the content on the business organization assessed during a predefined time period.

21. The computer program product of claim 20, wherein program instruction means for classifying the content classify the content in the knowledge ontology based on at least one natural language processing technique selected from a group including: latent semantic analysis, probabilistic latent semantic analysis, and computational linguistics.
